(19) United States
(12) Patent Application Publication
(10) Pub. No.: US 2022/0164325 A1
(43) Pub. Date: May 26, 2022

(54) DATA VALIDATION USING INFERRED PATTERNS

(71) Applicant: Microsoft Technology Licensing, LLC, Redmond, WA (US)

(72) Inventors: Yeye HE, Bellevue, WA (US); Jie SONG, Ann Arbor, MI (US)

(73) Assignee: Microsoft Technology Licensing, LLC, Redmond, WA (US)

(21) Appl. No.: 17/104,145

(22) Filed: Nov. 25, 2020

(51) Int. Cl. G06F 16/215; G06F 16/21; G06F 16/23

(52) U.S. Cl. CPC G06F 16/215; G06F 16/2365; G06F 16/211

(57) ABSTRACT

Aspects of the present disclosure relate to data validation using inferred patterns. Columns of a data store may be processed to generate a set of candidate patterns for each respective column, which may be combined to form a combined set of candidate patterns. Columns of the data store may then be processed using the combined set of candidate patterns to generate pattern scores for each candidate pattern with respect to each respective column. The candidate patterns may be ranked according to the pattern scores for given column. For example, the patterns may be ranked using an impurity score indicative of the percentage of rows not represented by a pattern and/or a coverage score indicative of a number of columns in a data store for which the pattern applies. A ranked pattern may be manually or automatically selected, which may then be applied to perform data validation of new data accordingly.

### BACKGROUND

As data pipelines grow more complex and the amount of data grows, data validation becomes increasingly difficult. Formatting changes and schema changes, among other potential modification issues, may cause gradual shifts in machine learning model performance (e.g., decreased accuracy) or, as another example, may cause failures in processes that have more rigid data expectations. Accordingly, identifying and remedying such issues may be time consuming, as the presence of a data quality issue may not even be immediately evident.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to data validation using inferred patterns to distinguish between valid data (e.g., data that conforms to an inferred pattern) and invalid data (e.g., data that does not conform to an inferred pattern). For example, columns of a data store may be processed to generate a set of candidate patterns for each respective column, which may be combined to form a combined set of candidate patterns. Columns of the data store may then be processed using the combined set of candidate patterns to generate pattern scores for each candidate pattern with respect to each respective column.

As a result of generating the pattern scores for each respective column, a set of candidate patterns may be provided in response to a user request or, as another example, may be used to automatically identify and apply a candidate pattern for data validation. The candidate patterns may be ranked according to the pattern scores for given column. For example, the patterns may be ranked according to an impurity score indicative of the percentage of rows not represented by a pattern and/or a coverage score indicative of a number of columns in a data store for which the pattern applies. The manually or automatically selected pattern may then be applied to perform data validation of new data accordingly.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for data validation using inferred patterns according to aspects of the present disclosure.

FIG. 2A illustrates an overview of an example method for generating a combined pattern set for data stored by a data lake.

FIG. 2B illustrates an overview of an example method for evaluating patterns of a combined pattern according to aspects of the present disclosure.

FIG. 2C illustrates an example generalization hierarchy for pattern generation according to aspects of the present disclosure.

FIG. 2D illustrates an example of data in a data lake in accordance with aspects of the present disclosure.

FIG. 3A illustrates an overview of an example method for providing a set of candidate patterns and receiving a selection associated therewith according to aspects of the present disclosure.

FIG. 3B illustrates an overview of an example method for validating data using an inferred pattern according to aspects of the present disclosure.

FIG. 4 is a block diagram illustrating example physical components of a computing device with which aspects of the disclosure may be practiced.

FIG. 5A is a simplified diagram of a mobile computing device with which aspects of the present disclosure may be practiced.

FIG. 5B is another simplified block diagram of a mobile computing device with which aspects of the present disclosure may be practiced.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

Large enterprise data lakes are increasingly common today, often with petabytes of data and millions of data assets (e.g., flat files or databases). Data estates are even larger, often including one or more data lakes. Each data lake may store data or data assets of the enterprise in a variety of data structures, in a form of columns and rows, for example. Data within such data stores may form part of a data pipeline, for example relating to machine learning (ML) modeling or business intelligence (BI) reporting. Such pipelines may recur on a regular basis (e.g., daily or weekly), as ML models are retrained or BI reports are refreshed. However, upstream data feeds may change in unexpected ways, thereby causing downstream applications (e.g., the ML models or BI reports) to experience issues. For example, schema-drift or data-drift may lead to issues that may be hard to detect (e.g., modest ML model degradation due to new or different values not seen in training) and/or hard to debug.

In some instances, a domain-specific language (DSL) may be used to manually specify a set of declarative constraints that describes attributes of “normal” or “expected” data. For example, a user may create such a set of constraints using the DSL, which is associated with a column to which it relates. Accordingly, the set of declarative constraints is used to identify unexpected deviations in the column as they occur. However, manually creating such constraints one column at a time is time consuming and does not scale well to larger environments.

Accordingly, aspects of the present disclosure relate to data validation using inferred patterns. As used herein, a pattern is a sequence of one or more tokens used to evaluate data to determine whether the data matches the pattern. If data is matched by the pattern, the data is “validated” according to the pattern. As an example, a pattern may comprise a sequence of tokens <digit>(1), literal “:”, and <alphanumeric>(2), such that the pattern matches 1:am but does not match 1:23. Example patterns include, but are not limited to, regular expressions and wildcard matching techniques. In examples, data columns of a data lake, data estate, or other data store are processed to generate a pattern set. The pattern set may comprise patterns of varying levels of restrictiveness for each of the processed columns. Each pattern of the pattern set may then be evaluated with respect to a column of the data store to generate a set of scores. The set of scores may indicate how well the pattern matches the data of the column, such that patterns of the generated pattern set may be ranked accordingly. Thus, patterns that rank highly may be used to perform automatic data validation or may be provided for selection by a user, thereby enabling the user to select a pattern that should be applied to validate data for a given column.

Thus, a user need not manually specify a set of declarative constraints to validate data within the data store. Further, while only a subset of columns (e.g., the most important columns or the most unreliable columns) may have traditionally warranted the time to manually create a respective set of declarative constraints, aspects of the present disclosure enable data validation of a greater number of columns. For example, columns may be automatically validated or a user may more easily select a pattern from a set of candidate patterns. Further, as discussed in greater detail below, aspects of the present disclosure ensure that the candidate patterns are neither too restrictive (e.g., as may be the case when merely using a rigid dictionary of previously identified values in a column) nor too permissive (e.g., as may be the case when using a pattern that is too general), thereby reducing the number of false positives while still retaining the ability to identify schema-drift or data-drift, among other potential data purity issues.

As noted above, multiple columns of a data store are processed to generate a combined pattern set for the data store. Each column may have an associated domain that represents valid values for the column. As an example, a column may comprise dates, where valid values for the column are in the format “yyyy-MM-dd” (e.g., “2020-11-19” or “2000-04-08”). As another example, another column may comprise timestamps in the format “h:mm:ss tt” (e.g., “9:03:24 AM” or “10:11:12 PM”). It will be appreciated that while example domains are described herein, any of a variety of other domains may be processed according to aspects of the present disclosure (e.g., email addresses, names, uniform resource locators (URLs), or file paths). For example, a domain may be specific to the data store in which the column resides and/or the business to which it relates (e.g., a serial number, a building and/or office number, a session identifier, or an employee identifier, among other proprietary domains).

In some instances, a column comprises multiple subdomains rather than a single domain. For example, a column may comprise both a date and a timestamp (e.g., “2020-11-19 9:03:24 AM”). In such instances, a set of subdomains may be generated for the column (e.g., a first relating to “2020-11-19” and a second relating to “9:03:24 AM”), such that each subdomain is processed according to aspects of the present disclosure. It will be appreciated that, in other instances, the column may be processed as a whole rather than splitting the column into its constituent subdomains.

Any of a variety of techniques may be used to generate a pattern for a column (e.g., relating to a domain or subdomain therein). As an example, each row of the column may be processed or, as another example, a subset of rows may be sampled from the column (e.g., randomly and/or according to age). A lexer may be used to tokenize the row, such that each token is used to form a part of a pattern for the column. In some instances, the row may be segmented according to one or more characters (e.g., a slash, dash, or whitespace) or using one or more offsets. Tokens may then be generalized according to a generalization hierarchy, thereby generating a set of generalizations for each token. The set of generalizations for each token may then be combined to yield a set of patterns for the column. In some instances, multiple rows are evaluated at a time (e.g., comparing or otherwise processing similar tokens across rows) in order to generate generalizations and the resulting set of patterns.

Using a simple timestamp as an example, “4:00” may be segmented according to the “:” character, and the first token “4” may be used to generate a set of generalizations comprising {“4”, <digit>(1), <digit>+, <alphanumeric>(1), <alphanumeric>+, and <all>}. In such an example, <digit>(1) indicates a single digit, while <digit>+ indicates a pattern that matches any number of digits. For example, <digit>+ may be matched in instances where there are zero digit tokens or, in other examples, a “+” may be matched by one or more digits while “*” may be matched by zero or more digits. The set of generalizations for the second token (e.g., “:”) may comprise {“:”, <symbol>(1), <symbol>+, and <all>}. Finally, the set of generalizations for the third token (e.g., “00”) may comprise {“00”, <digit>(2), <digit>+, <alphanumeric>(2), <alphanumeric>+, and <all>}. As noted above, the generalizations are combined, for example yielding a pattern candidate of “4”, “:”, “00” or another example pattern candidate of <digit>+, <symbol>(1), <digit>+. The first candidate is typically thought of as too narrow, as it only matches “4:00,” while the second example may be too broad, as it would match “45-9192,” rather than more strictly matching the column domain (e.g., simple timestamps). Consequently, a preferred candidate pattern might be <digit>+, “:”, <digit>(2), which may match instances with a single number for the hour (e.g., 4:00) as well as instances where two digits are used (e.g., 12:00 or 16:00).

Thus, aspects described herein need not generate a set of patterns for a domain that exactly match the domain of the column. Further, as compared to generating a more rigid dictionary of values based on pre-existing data, the disclosed techniques may more accurately validate data that has not yet been observed by the system. Thus, when processing a column comprising timestamps only ending in “AM,” other approaches may incorrectly invalidate subsequent data comprising timestamps ending in “PM,” even though such a timestamp is valid. Additionally, patterns may be inferred for data having a domain that is nonstandard or otherwise uncommon. As noted above, certain data may be specific to a data store or business, among other proprietary domains. Rather than requiring that a custom set of declarative constraints be created, a set of candidate patterns may instead be inferred according to aspects of the present disclosure.

While example pattern representations and generation techniques are described, it will be appreciated that any of a variety of other notations and/or representations may be used (e.g., regular expressions or wildcards, etc.). Similarly, any of a variety of other techniques may be used to generate a set of candidate patterns for a set of data.

In addition to generating a set of patterns for columns of a particular data store, a combined pattern set for the data store itself may be generated. The combined pattern set may be a union of the patterns generated for each respective column, such that the combined pattern set is a unique set of patterns based on patterns for each respective column. It will be appreciated that the combined pattern set need not be used to perform data validation only for that specific data store from which it was generated. Rather, a combined pattern set may be used to process another, different data store. For example, a data estate may have multiple data lakes, such that a combined pattern set may be generated for a first data lake and subsequently used to perform data validation for one or more other data lakes.

Columns of the data store are evaluated using the combined pattern set to generate an index of patterns and associated scores. For example, a pattern may be scored according to an “impurity” score (or, in other examples, a false positive score), which represents the percentage of values in a given column that do not match the pattern. As another example, a coverage score may be generated for a pattern, where the coverage score represents a number of columns in a data store that that match the pattern (e.g., having an impurity score below a certain threshold). For example, the coverage score may be used to address instances where a pattern has a low impurity score (and thus appears to have a high level of accuracy) but fails to address domains of at least a predetermined number of columns. Thus, a pattern may be scored on a per-column basis and/or with respect to multiple columns in the data store.

In some instances, columns may have non-conforming values that, if left unaddressed, may negatively affect a pattern's impurity score. For example, a value of “N/A” or “-” may indicate that a row does not have data in a given column. Such values may periodically occur and may not be indicative of a data validation issue. Accordingly, a pattern may have an associated tolerance parameter that indicates a fraction of non-conforming values that a pattern is permitted to exhibit. The tolerance parameter may be used when evaluating incoming data, as discussed in greater detail below. {INVENTORS: IS THERE MORE DETAIL WE CAN INCLUDE REGARDING HOW THE TOLERANCE PARAMETER AND IMPURITY SCORE/FALSE POSITIVE RATE ARE INTERRELATED OR HOW THEY ARE DIFFERENT?}

Similar to the sampling discussion above with respect to pattern generation, a pattern may be scored using all values of a column or, in other examples, may be scored according to a sampling of values therein (e.g., randomly and/or according to age). Thus, as a result of performing such a large-scale analysis of potentially related columns and data stores, it is possible to generate and identify patterns for data validation that match columns and associated domains. Such techniques are further applicable and may even excel in instances where proprietary or otherwise foreign domains may otherwise be difficult to address using manually defined declarative constraints.

The pattern generation and scoring techniques described above may be performed periodically and/or in response to one or more events (e.g., the addition of an amount of data above a threshold or in response to a request by a user). For example, they may be performed offline, such that an index of patterns and associated scores is available for subsequent queries (e.g., to provide a set of candidate patterns for user selection or to automatically apply a pattern for data validation). In such instances, the amount of time required to generate the set of candidate patterns and present the set to the user may be reduced, thereby improving an associated user experience. Further, offline processing may be performed in instances where computation demand is otherwise low, thereby reducing a potential impact on system performance. It will be appreciated that “offline” processing need not be performed when the data store is offline or otherwise unavailable for normal operations. Rather, such offline processing may be performed prior to receiving user requests and/or performing data validation accordingly. In other instances, offline processing and online processing may occur contemporaneously.

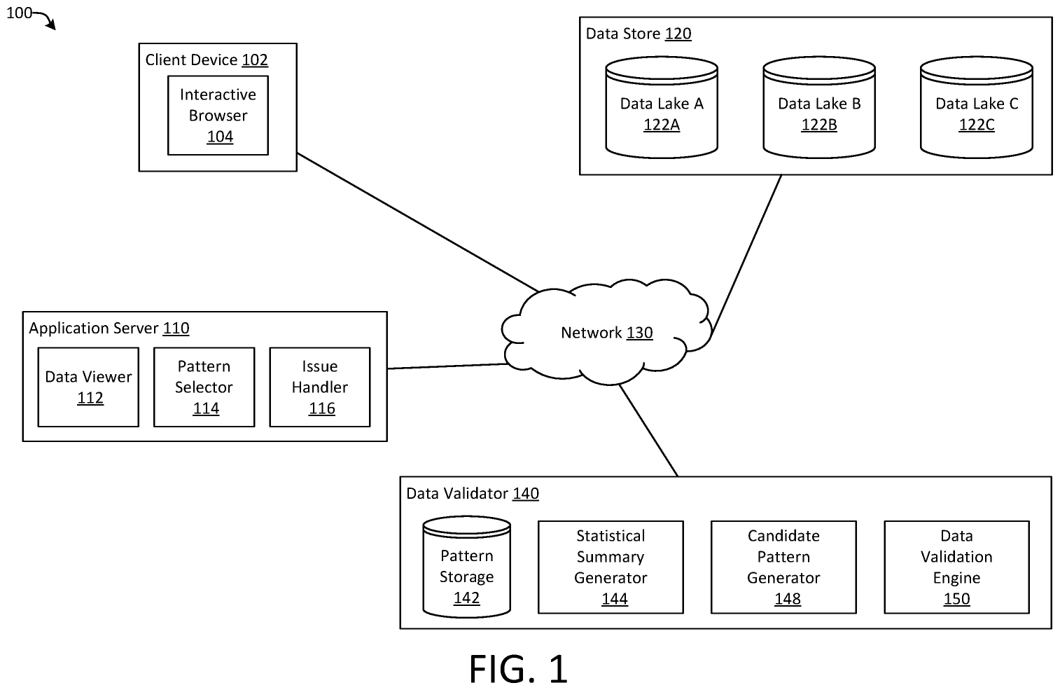

FIG. 1 illustrates an overview of an example system 100 for data validation using inferred patterns according to aspects of the present disclosure. As illustrated, system 100 includes a client device 102, an application server 110, a network 130, and a data validator 140 for generating, scoring, and using patterns for validating data of a data store 120. The client device 102 communicates with the application server 110, which includes a data viewer 112, a pattern selector 114, and an issue handler 116. Accordingly, an interactive user interface associated with application server 110 may be presented to a user of client device 102 via interactive browser 104. For example, interactive browser 104 may be a web browser that accesses the interactive user interface, may be a native application, or any combination thereof.

The data store 120 includes one or more data lakes, a data lake A 122A, a data lake B 122B, and a data lake C 122C, for example. Each data lake includes data of various data types and formats. In examples, the data store 120 may be a data estate. The network 130 provides network connectivity the client device 102, the application server 110, the data store 120, and the data validator 140. The data validator 140 includes a pattern storage 142, a statistical summary generator 144, a candidate pattern generator 148, and a data validation engine 150.

The client device 102 connects with the application server 110 via the network 130 to execute applications that include user interactions through the interactive browser 104. The application server 110 interacts with the client device 102 and the data validator 140 via the network 130 to provide candidate sets of patterns and receive selections thereof. The data validator 140 connects via the network 130 with the client device 102 through the connection with the application server 110 and the data store 120 for generating candidate patterns and associated scores, as well as ultimately performing data validation according to aspects described herein.

The client device 102 may be a computing device providing user-input capabilities e.g., the interactive browser 104 for user input in aiding the process of pattern selection, as well as handling data validation issues (as may be identified by data validation engine 150 and handled by issue handler 116). The interactive browser 104 may render graphical user interface by processing as a web browser, for example. In aspects, the client device 102 may communicate over the network 130 with the application server 110.

As noted above, the application server 110 includes the data viewer 112, the pattern selector 114, and the issue handler 116. The data viewer 112 provides rendering of data in data lakes for viewing by the user. In some instances, the data viewer 112 may receive an indication from issue handler 116 to access and display data associated with a data validation issue, as may be identified by the data validation engine 150. In other examples, the data viewer 112 may generate a display of data that validates successfully according to a selected candidate pattern, such that a user may determine how well a pattern matches a given column of data. The pattern selector 114 may receive an interactive selection of a pattern from a set of candidate patterns for a given column. For example, a set of candidate patterns may be received from the candidate pattern generator 148, such that at least a subpart of the set is provided to interactive browser 104 for user selection. The issue handler 116 may receive an indication of a validation issue from data validation engine 150, such that it may display such an indication via the interactive browser 104 on the client device 102.

The data store 120 may include one or more data lakes 122A-122C. Each data lake may store data. Data in respective data lakes may be in a variety of formats, such as a format based on columns and rows or, as another example, a directed or undirected graph with nodes and edges. Respective data lakes may accommodate one or more data connectors for applications and tools to access the data in the respective data lakes based on one or more types of data formats.

While system 100 shows the data store 120 as having the data lake A 122A, the data lake B 122B, and the data lake C 122C, it will be appreciated any of a variety of other data stores may be used. For example, cloud storage, distributed data storage, centralized data storage, a data farm, or data swamp, etc. A data store may further be volatile or non-volatile.

As noted above, the data validator 140 generates candidate patterns and scores patterns based on data stored by the data store 120. The data validator 140 further validates data of the data store 120 according to one or more manually and/or automatically selected patterns. The data validator 140 is illustrated as comprising the pattern storage 142, the statistical summary generator 144, the candidate pattern generator 148, and the data validation engine 150.

In examples, the candidate pattern generator 148 accesses a column of data from the data store 120 and generates a set of candidate patterns based on that column. For example, the candidate pattern generator 148 may process every row of the accessed column or a subset thereof (e.g., as may be sampled randomly or according to age, among other examples). The candidate pattern generator 148 may use a lexer to tokenize rows of the column, such that a set of generalizations may be generated for each token, which may then be combined to generate a set of candidate patterns for the row according to aspects described herein. The candidate pattern generator 148 may store the set of candidate patterns in pattern storage 142.

The candidate pattern generator 148 may process multiple columns of the data store 120, for example from the data lake A 122A, the data lake B 122B, and/or the data lake C 122C. Accordingly, the candidate pattern generator 148 may store each set of candidate patterns in the pattern storage 142. As noted above, a union of the generated sets of candidate patterns may be stored in the pattern storage 142, thereby yield a combined pattern set that comprises unique patterns generated based on the processed columns.

In aspects, the statistical summary generator 144 may generate a set of scores for patterns stored by the pattern storage 142. For example, the statistical summary generator 144 may process a column of the data store 120 to generate an impurity score, a coverage score, and/or a tolerance parameter for a pattern stored by the pattern storage 142. As discussed above, each pattern of pattern storage 142 may be processed as compared to the column of the data store 120. In other examples, a subset of patterns may be processed, for example based at least in part on a data lake with which the column and pattern are both associated or identifying patterns associated with columns having similar lengths. Scores generated by the statistical summary generator 144 may be stored in association with patterns in the pattern storage 142, thereby creating an index of patterns and associated scores for a given column.

Pattern generation by the candidate pattern generator 148 and/or score generation by the statistical summary generator 144 may be performed offline (e.g., as preprocessing prior to receiving a user request for a set of candidate patterns) or online, among any of a variety of other such paradigms. As another example, such column processing may be performed in parallel, such that multiple columns of the data store 120 are processed for pattern generation and/or score generation contemporaneously.

In examples, the interactive browser 104 of the client device 102 is used to access functionality of the data viewer 112 in order to view data of the data store 120. A user of the client device 102 may select a column of the data store 120, thereby causing interactive browser 104 to generate a request for a set of candidate patterns that may be used to validate the selected column. Accordingly, the candidate pattern generator 148 may access the index of patterns and associated scores from the pattern storage 142. For example, the candidate pattern generator 148 may access scores associated with the selected column. Accordingly, the candidate pattern generator 148 may rank patterns of the pattern storage 142 according to the scores associated with the select column, such that at least a part of the ranked list of candidate patterns may be provided to the client device 102 (e.g., via application server 110). As discussed above, the set of candidate patterns and associated scores may be generated offline or, in other examples, at least a part of such processing may be performed in response to the request generated by the interactive browser 104.

As a result, the interactive browser 104 may present at least a subset of the received candidate patterns to the user, thereby enabling the user to evaluate the displayed candidate patterns and select a candidate pattern accordingly. In some instances, the interactive browser 104 may enable the user to edit a candidate pattern prior to selection or, as another example, may process at least a part of the data of the selected column in order to provide a “preview” of how a selected candidate pattern may perform. Once a user selects and/or edits a pattern, pattern selector 114 may receive an indication of the user's selection, which may be provided to the data validation engine 150, such that the selected pattern is associated with the selected column, thereby causing the data validation engine 150 to validate new data according to the indicated pattern.

In other examples, the data validation engine 160 may automatically identify a pattern with which to validate data in addition to or as an alternative to such user input. For example, the data validation engine 150 may request or otherwise access a ranked set of candidate patterns (e.g., as may be generated by the candidate pattern generator 148), such that the highest ranked pattern is applied for data validation. It will be appreciated that any of a variety of other techniques may be used to automatically select a candidate pattern, for example selecting a candidate pattern that is most commonly applied (e.g., as a result of manual and/or automatic selection) to perform data validation within the data store 120.

The data validation engine 150 applies generated patterns as described above. Accordingly, if the data validation engine 150 identifies a data validation issue, an indication may be provided to issue handler 116, such that one or more actions may be taken. Example actions include, but are not limited to, providing an indication via interactive browser 104, such that a user may evaluate the identified validation issue and associated data. In other examples, issue handler 116 may attempt to automatically remedy the identified data validation issue (e.g., by removing extraneous characters or resolving transposed information). In some instances, an indication presented via the interactive browser 104 may further comprise a suggested action to remedy the identified validation issue.

While FIG. 1 is described in an instance where the client device 102, the application server 110, the data store 120, and the data validator 140 communicate over the network 130, it will be appreciated that any of a variety of other configurations may be used. For example, at least a part of the aspects discussed above with respect to the data validator 140 may be implemented by the data store 120 or, as another example, at least a part of the functionality described above with respect to the application server 110 may be implemented by the interactive browser 104 and/or the client device 102.

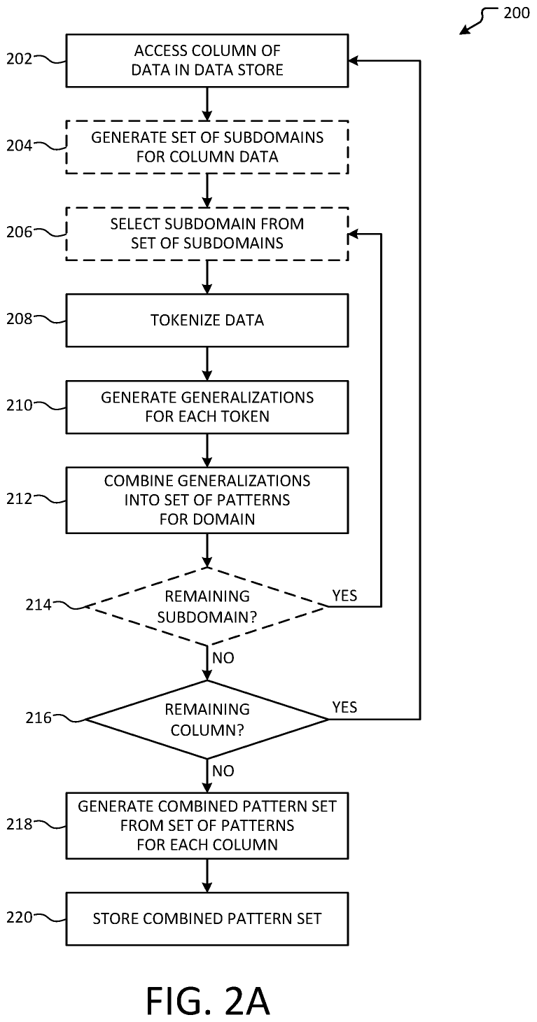

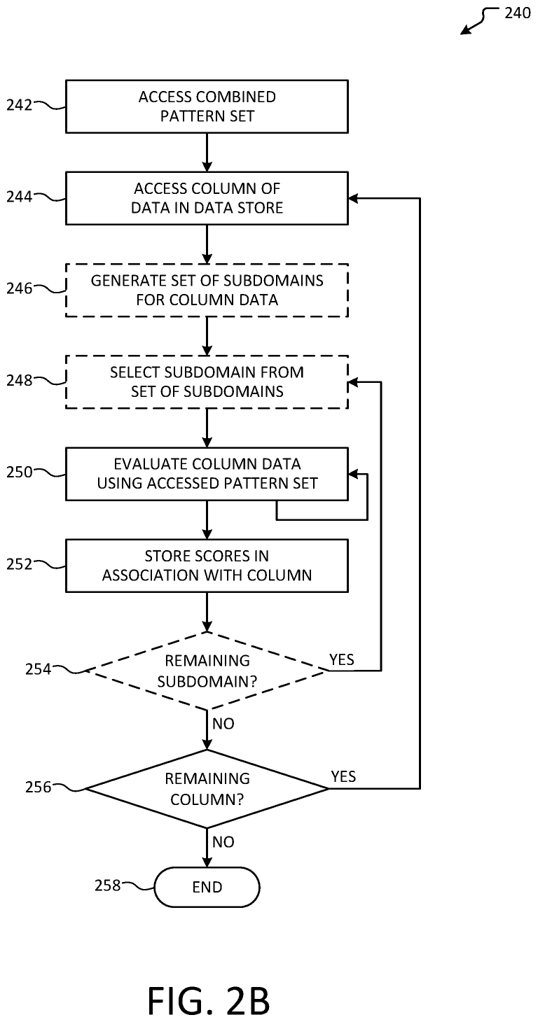

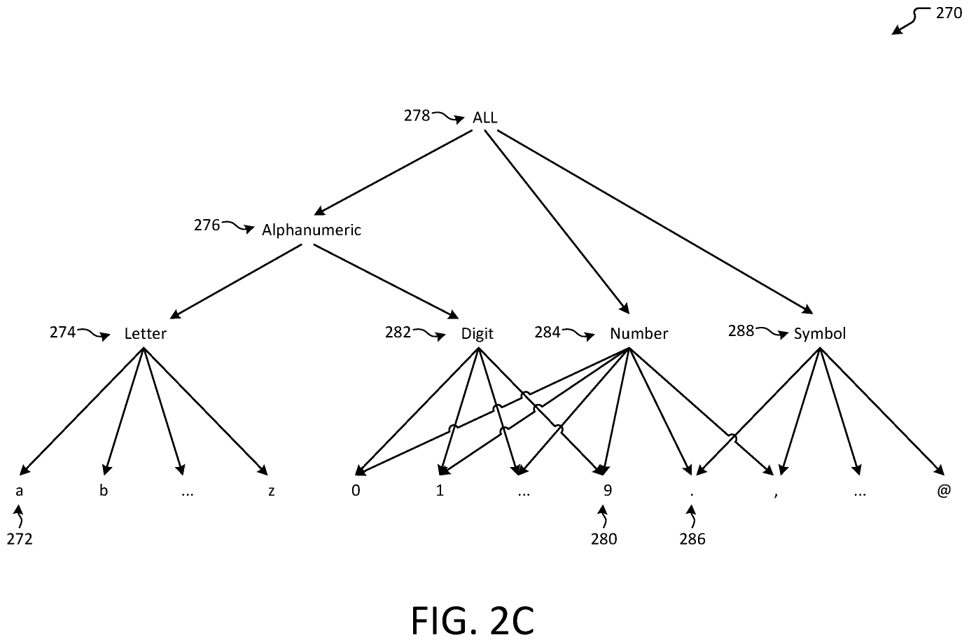

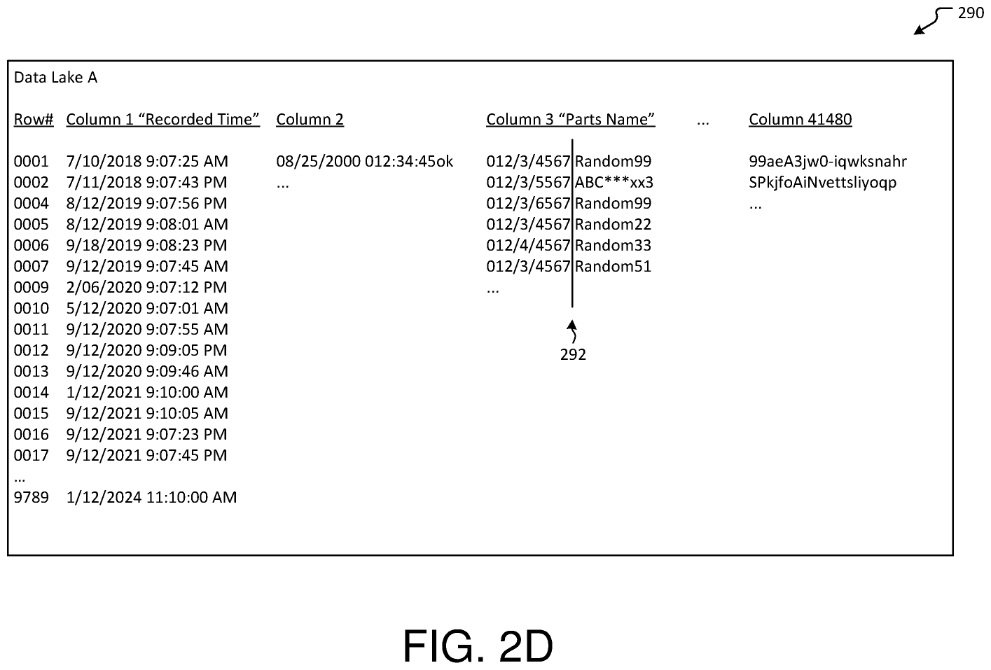

FIG. 2A illustrates an overview of an example method 200 for generating a combined pattern set for data stored by a data lake. In examples, aspects of method 200 may be performed by a candidate pattern generator, such as the candidate pattern generator 148 in FIG. 1.

Method 200 begins at operation 202, where a column of data is accessed in a data store. The data store may be a data lake or a data estate, such as the data lakes 122A-C of the data store 120 in FIG. 1. In some instances, columns may be accessed sequentially, randomly, or according to columns that have recently be updated.

At operation 204, a set of subdomains is generated for the column. As discussed above, a column may comprise a domain that comprises multiple subdomains. Accordingly, the column may be split into its constituent subdomains at operation 204. In some instances, multi-sequence alignment techniques may be used to align subdomains across multiple rows. As another example, different subset configurations (e.g., from indices 0 to 4 and 5 to 10, 0 to 7 and 8 to 10, etc.) may be evaluated as compared to an existing set of candidate patterns to determine which subset configuration exhibits a higher score (e.g., impurity, coverage, etc.).

Flow progresses to operation 206, where a subdomain is selected from the set of subdomains that was generated at operation 204. Operations 204 and 206 are illustrated using dashed boxes to indicate that, in some instances, operations 204 and 206 may be omitted. For example, if the column does not comprise multiple subdomains, the column may not be split into its constituent subdomains and may be instead processed as a whole. In such instances, flow progresses from operation 202 to operation 208 accordingly.

Moving to operation 208, data of a row (e.g., relating to a domain or a subdomain as selected at operation 208) is tokenized. As described above, a lexer may be used to tokenize the row such that each token is used to form a part of a pattern for the column. In some instances, the row may be segmented according to one or more characters (e.g., a slash, dash, or whitespace) or using one or more offsets. In examples, rows of a column are processed sequentially, randomly, or contemporaneously with one or more other rows.

Flow progresses to operation 210, where generalizations are generated for each token. For example, tokens may be generalized according to a hierarchy, thereby generating a set of generalizations for each token. For example, a set of generalizations for a token “4” may include {“4”, <digit>(1), <digit>+, <alphanumeric>(1), <alphanumeric>+, and <all>}. While example pattern representations and generation techniques are described, it will be appreciated that any of a variety of other notations and/or representations may be used (e.g., regular expressions or wildcards, etc.). Similarly, any of a variety of other techniques may be used to generate a set of candidate patterns for a set of data.

Flow progresses to operation 212, where the generalizations generated at operation 210 are combined to yield a set of patterns for the domain (or subdomain, as discussed above). For example if a first set of generalizations comprises {<alphanumeric>(2) and <all>+} and a second set of generalizations comprises {<digit>(1) and <digit>+}, the resulting set of patterns for the domain may comprise the combinations associated therewith: {<alphanumeric>(2) and <digit>(1); <alphanumeric>(2) and <digit>+; <all>+ and <digit>(1); and <all>+ and <digit>+}.

At determination 214, it is determined whether there are remaining subdomains to process from the set that was generated at operation 204. If there is a remaining subdomain, flow branches “YES” and returns to operation 206, where another subdomain is selected from the generated set. If, however, there are no remaining subdomains, flow instead branches “NO” to determination 216, which is discussed below. As noted above, a column may not be split into its constituent subdomains, such that determination 214 may be omitted in instances where operations 204 and 206 are similarly omitted. In such instances, flow progresses from operation 212 to determination 216.

At determination 216, it is determined whether there is a remaining column of the data store to process. If it is determined that there is a remaining column to process, flow branches “YES” to operation 202, where a subsequent column is accessed. As noted above, the column may be access sequentially, randomly, or according to any of a variety of other techniques. Thus, flow loops through operations 202-216 until it is determined that there are not remaining columns to process.

If, at determination 216, it is eventually determined that there are no remaining columns, flow branches “NO” to operation 218, where a combined pattern set is generated from the set of patterns that was generated for each column (e.g., as were generated by performing operation 212). In examples, the combined pattern set is a union of the patterns that were generated for each respective column, such that the combined pattern set is a unique set of patterns based on patterns for each respective column.

Flow progresses to operation 220, where the combined pattern set is stored. For example, the combined pattern set may be stored in a pattern storage, such as the pattern storage 142 in FIG. 1. In some instances, the combined pattern set may replace a previously existing pattern set or, as another example, the combined pattern set may be stored in such a way that updates a preexisting pattern set. Thus, it will be appreciated that similar techniques may be performed to incrementally update an existing combined pattern set. Flow terminates at operation 220.

FIG. 2B illustrates an overview of an example method 240 for evaluating patterns of a combined pattern according to aspects of the present disclosure. In examples, aspects of method 240 are performed by a statistical summary generator, such as the statistical summary generator 144 in FIG. 1.

Method 240 begins at operation 242, where a combined pattern set is accessed. For example, the combined pattern set is accessed from a pattern storage, such as pattern storage 142 in FIG. 1. The accessed combined pattern set may have been generated according to aspects of method 200 discussed above with respect to FIG. 2A.

Flow progresses to operation 244, where a column of data is accessed in a data store. The data store may be a data lake or a data estate, such as the data lakes 122A-C of the data store 120 in FIG. 1. In some instances, columns may be accessed sequentially, randomly, or according to columns that have recently be updated.

At operation 246, a set of subdomains is generated for the column data. For example, the column may comprise a domain that comprises multiple subdomains. Accordingly, the column may be split into its constituent subdomains at operation 246. In some instances, multi-sequence alignment techniques may be used to align subdomains across multiple rows. As another example, different subset configurations (e.g., from indices 0 to 4 and 5 to 10, 0 to 7 and 8 to 10, etc.) may be evaluated as compared to an existing set of candidate patterns to determine which subset configuration exhibits a higher score (e.g., impurity, coverage, etc.).

Flow progresses to operation 248, where a subdomain is selected from the set of subdomains that was generated at operation 246. Operations 246 and 248 are illustrated using dashed boxes to indicate that, in some instances, operations 246 and 248 may be omitted. For example, if the column does not comprise multiple subdomains, the column may not be split into its constituent subdomains and may be instead processed as a whole. In such instances, flow progresses from operation 244 to operation 250 accordingly.

At operation 250, the column data is evaluated using the accessed pattern set. For example, at least a part of the column data (e.g., relating to a domain or a subdomain, as may be sampled randomly, by age, or using a variety of other techniques) is evaluated according to a pattern of the pattern set in order to generate a set of scores. For example, an impurity score and/or coverage score may be generated. In some instances, a tolerance parameter is further generated for the pattern with respect to the column, such that the tolerance parameter is indicative of a certain ratio of non-conforming values in the column. An arrow is illustrated from operation 250 to operation 250 to illustrate that operation 250 may be performed multiple times, in order to generate a set of scores for each pattern of the combined pattern set with respect to the column.

Eventually, flow progresses to operation 252, where the sets of scores generated at operation 250 are stored in association with the column. For example, the scores may be stored in a pattern storage, such as the pattern storage 142 in FIG. 1. Thus, for each evaluated pattern, a set of scores is stored in association with the column that was accessed at operation 244.

At determination 254, it is determined whether there are remaining subdomains to process from the set that was generated at operation 246. If there is a remaining subdomain, flow branches “YES” and returns to operation 248, where another subdomain is selected from the generated set. If, however, there are no remaining subdomains, flow instead branches “NO” to determination 256, which is discussed below. As noted above, a column may not be split into its constituent subdomains, such that determination 254 may be omitted in instances where operations 246 and 248 are similarly omitted. In such instances, flow progresses from operation 252 to determination 256.

At determination 256, it is determined whether there is a remaining column of the data store to process. If it is determined that there is a remaining column to process, flow branches “YES” to operation 244, where a subsequent column is accessed. As noted above, the column may be access sequentially, randomly, or according to any of a variety of other techniques. Thus, flow loops through operations 244-256 until it is determined that there are not remaining columns to process.

If, at determination 256, it is eventually determined that there are no remaining columns, flow branches “NO” and ends at operation 258. Thus, method 240 generates an index of patterns and associated scores for a given column, such that it may later be referenced and used to generate a set of candidate patterns according to aspects described herein. In examples, methods 200 and 240 in FIGS. 2A and 2B, respectively, may be performed sequentially or contemporaneously, among other examples. In other instances, method 240 may be performed separate from method 200, such that the set of scores is updated for an existing set of patterns (as was generated by a previous execution of method 200) when new data is added to the data store.

FIG. 2C illustrates an example generalization hierarchy 270 for pattern generation according to aspects of the present disclosure. As noted above, a row may be split into multiple tokens, which may be generalized according to a generalization hierarchy such as generalization hierarchy 270. In examples, a token is matched at the lowermost leaf node, and then the tree is traversed upwards, adding more general nodes to the set of generalizations as discussed above.

For example, token “a” 272 may be added to the set of generalizations, after which the tree is traversed upward to further add “<letter>” 274, “<alphanumeric>” 276, and “<all>” 278. Generalization hierarchy 270 further illustrates that a token need not generalize into a single generalization, but rather may generalize into any number of generalizations. For example, “9” token 280 generalizes into both “<digit>” 282 and “<number>” 284. Accordingly, the full set of generalizations for “9” token 280 as illustrated by generalization hierarchy 270 is {<digit>, <alphanumeric>, <number>, and <all>}. Similarly, “.” token 286 generalizes into both “<number>” 284 and “<symbol>” 288. Accordingly, the full set of generalizations for “.” token 286 as illustrated by generalization hierarchy 270 is {<number>, <symbol>, and <all>}.

FIG. 2D illustrates an example of data in a data lake in accordance with aspects of the present disclosure. Data 290 may represent data at least in part of data lake A 122 of FIG. 1. Data 290 is in a data format of rows and columns, for example. Only a part of data is shown in FIG. 2D for purposes of illustration. In row 0001, column 1 includes data “7/10/2018/9:07:25 AM,” column 2 includes “08/25/2000 012:34:45ok”, column 3 includes data “012/3/4567 Random99,” and column 41480 includes a value “99aeA3jw0-iqwksnahr,” for example.

As shown by data 290, data in different columns may be in distinct data formats or patterns. Column 1 comprises timestamp data, for example. The timestamp data may include data, time, and an identifier of AM or PM. In some examples, the timestamp data may be standardized but in other embodiments, it may be customized. For example, column 2 includes a row 1 with a value “8/25/2000 012:34:45ok,” which represents a custom data format particularly in the part “012:34:45ok,” for example.

Columns of data 290 may be processed according to the disclosed aspects. For example, a candidate pattern set may be generated from a union of candidate patterns for columns 1, 2, 3, and 4, which may subsequently be evaluated as compared to each of columns 1, 2, 3, and 4. In some instances, column 2 may be identified to have multiple subdomains, for example relating to a timestamp (e.g., “08/25/2000 012:34:45”) and other text (e.g., “ok”). Column 3 is further illustrated as comprising separator 292, to illustrate that, similar to Colum 2, it too may be split into multiple subdomains (e.g., a first subdomain to the left of separator 292 and a second subdomain to the right of separator 292).

Accordingly, each subdomain of column 2 may be evaluated according to the candidate pattern set for all of data 290 (e.g., which further comprises candidate patterns generated for constituent subdomains of column 2). In such examples, one or more patterns generated based on column 1 may exhibit favorable scores, as the data in columns 1 and 2 is at least similar in part. In fact, certain candidate patterns generated for column 1 may have been the same as candidate patterns for column 2 (though only one instance of such a candidate pattern would be in the union of candidate patterns). Thus, columns within a data store as illustrated by data 290 may be usable to generate patterns for validating one or more other columns within the data store.

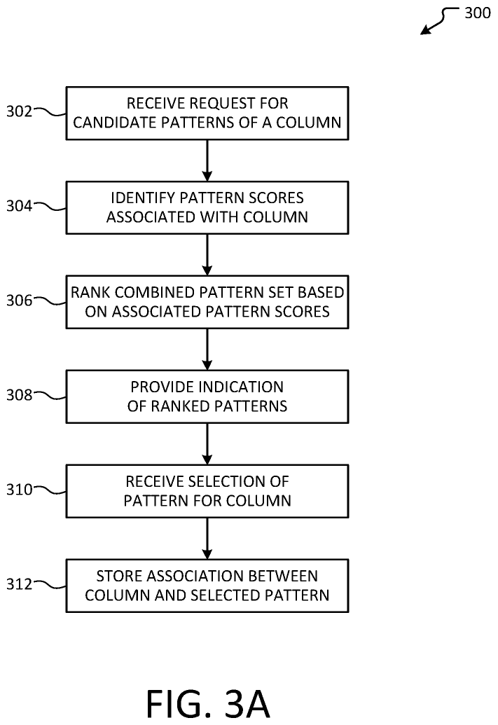

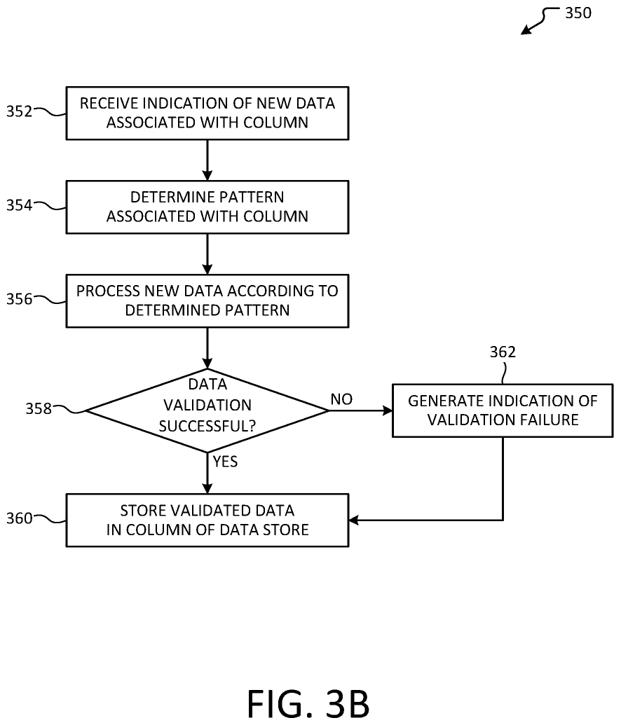

FIG. 3A illustrates an overview of an example method 300 for providing a set of candidate patterns and receiving a selection associated therewith according to aspects of the present disclosure. In examples, aspects of method 300 are performed by a data validator and/or an application server, such as the data validator 140 and/or the application server 110 in FIG. 1.

Method 300 begins at operation 302, where a request for candidate patterns for a column is received. In examples, the request is received from a client device, such as the client device 102 in FIG. 1. For example, the interactive browser 104 of the client device 102 in FIG. 1 may generate a request for candidate patterns in response to a user selection to view candidate patterns for a given row. In some examples, the request comprises an indication as to a row for which candidate patterns are requested. In other examples, the request comprises an indication as to a range of rows or, as another example, the request may be for candidate patterns associated with all rows of a data store.

Flow progresses to operation 304, where pattern scores associated with the indicated column(s) are identified. For example, the scores may be stored by a pattern storage, such as the pattern storage 142 in FIG. 1. The scores may have been generated by a statistical summary generator (e.g., statistical summary generator 144 in FIG. 1) performing aspects of operations 250-252 in FIG. 2B. Thus, the pattern scores associated with the column may be identified from an index of scores and associated patterns.

At operation 306, patterns in a combined pattern set are ranked based on the accessed pattern scores. As noted above, the pattern scores may indicate how well a given pattern matches the data of a column, such that patterns of the generated pattern set may be ranked accordingly. Patterns may be ranked according to an impurity score, a coverage score, and/or a tolerance parameter. For example, a weighted score may be generated based on the set of pattern scores associated with the pattern. In some examples, patterns that have a score below or above a predetermined threshold, or outside of a predetermined range may be omitted. For example, patterns may be filtered such that a coverage score is above a first predetermined threshold and an impurity score is blow a second predetermined threshold, and further ranked according to impurity score. Thus, it will be appreciated that any of a variety of techniques may be used to rank a candidate set of patterns.

Flow progresses to operation 308, where an indication of the ranked patterns is provided. For example, the indication is provided to the client device from which the request was received at operation 302. In examples, the indication comprises a subset of the ranked patterns, for example according to patterns that score above a predetermined threshold. In other examples, the ranked set is paginated, such that the ranked set may be provided one page at a time.

At operation 310, a selection of a pattern for a column may eventually be received. In examples, the selection comprises an indication of a pattern from the ranked set of patterns. In other examples, the indication comprises an edited pattern, such that the edited pattern may be used for data validation instead of the pattern that was initially provided at operation 308.

Moving to operation 312, an association is stored between the column and the pattern that was selected at operation 310. For example, an indication may be provided to a data validation engine (e.g., data validation engine 150 in FIG. 1) to use the selected pattern to perform data validation for the given column. As noted above, the request received at operation 302 may indicate multiple columns. Thus, it will be appreciated that similar techniques may be used to provide ranked patterns and receive pattern selections for additional columns, for example in bulk or iteratively. Flow terminates at operation 312.

FIG. 3B illustrates an overview of an example method 350 for validating data using an inferred pattern according to aspects of the present disclosure. Aspects of method 350 may be performed by a data validation engine, such as the data validation engine 150 in FIG. 1. Method 350 begins at operation 352, where an indication of new data associated with a column is received. For example, the indication may be received in response to new data being added to a data store (e.g., the data store 120 in FIG. 1). As another example, the indication may be received as a result of a predetermined amount of time passing since method 350 was last executed. Thus, it will be appreciated that data validation may occur as data is received, according to a schedule, or in response to any of a variety of other events.

Flow progresses to operation 354, where a pattern associated with the column is determined. For example, operation 354 may comprise identifying a user-specified association between the column and the pattern, as may have been generated as a result of operation 312 discussed above with respect to method 300 in FIG. 3A. As another example, the pattern may be determined automatically based on accessing and evaluating pattern scores associated with the column, similar to the ranking operations discussed above with respect to operation 306 of method 300 in FIG. 3A. As a result, the highest-ranked pattern may be automatically applied to perform data validation.

At operation 356, the new data is processed according to the pattern that was determined at operation 354. Thus, each row of data may be parsed according to the pattern in order to determine whether the row conforms to the pattern. If no nonconforming rows are identified, data validation may be termed successful. In other examples, a tolerance parameter associated with the pattern (e.g., as may be stored by pattern scores for the pattern and the associated column) is evaluated to determine whether a deviation from the observed tolerance parameter is statistically significant in the new data. As a further example, a certain amount of deviation may be permitted.

Accordingly, at determination 358, it is determined whether data validation was successful. If validation is not determined to be successful, flow branches “NO” to operation 362, where an indication of validation failure is generated. For example, the indication may be provided to an issue handler, such as issue handler 116 in FIG. 1. As a result, an indication may be presented to a user. The indication may comprise the pattern that was used to perform the validation and/or the data that failed validation, among other examples. As another example, the indication generated at operation 362 may result in an attempt to automatically remedy the validation failure. In some instances, flow pauses at operation 362 while the validation failure is remedied. For example, an indication may be received to omit the data that failed validation or, as another example, the indication may comprise an instruction to add the data even in light of the failed validation (e.g., as the validation failure was a false positive). Accordingly, flow progresses to operation 360, where the data is added to the column of the data store accordingly.

If, however, it is determined that data validation was successful, flow instead branches “YES” to operation 360, where the data is stored in the column of the data store. While method 350 is illustrated as processing a single column of new data, it will be appreciated that similar techniques may be used to process multiple columns of data contemporaneously. Method 350 terminates at operation 360.

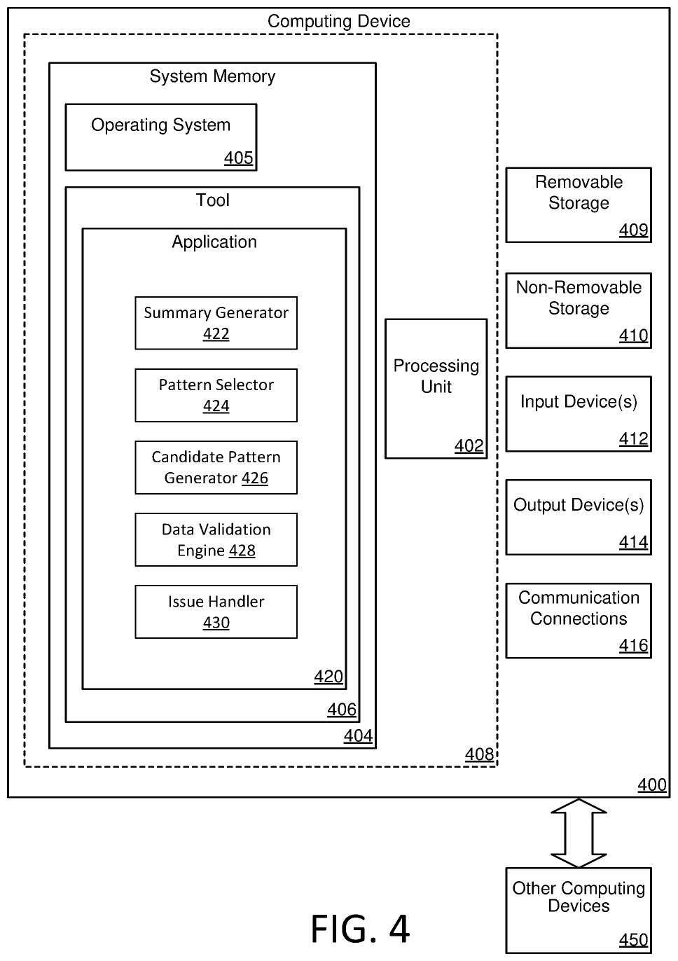

FIG. 4 is a block diagram illustrating physical components (e.g., hardware) of a computing device 400 with which aspects of the disclosure may be practiced. The computing device components described below may be suitable for the computing devices described above. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program tools 406 suitable for performing the various aspects disclosed herein such. The operating system 405, for example, may be suitable for controlling the operation of the computing device 400. Furthermore, aspects of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program tools and data files may be stored in the system memory 404. While executing on the at least one processing unit 402, the program tools 406 (e.g., an application 420) may perform processes including, but not limited to, the aspects, as described herein. The application 420 includes a summary generator 422, a pattern selector 424, a candidate pattern generator 426, a data validation engine 428, and an issue handler 430, as described in more detail with regard to FIG. 1. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 400 may also have one or more input device(s) 412, such as a keyboard, a mouse, a pen, a sound or voice input device, a touch or swipe input device, etc. The output device(s) 414 such as a display, speakers, a printer, etc. may also be included. The aforementioned devices are examples and others may be used. The computing device 400 may include one or more communication connections 416 allowing communications with other computing devices 450. Examples of suitable communication connections 416 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 404, the removable storage device 409, and the non-removable storage device 410 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

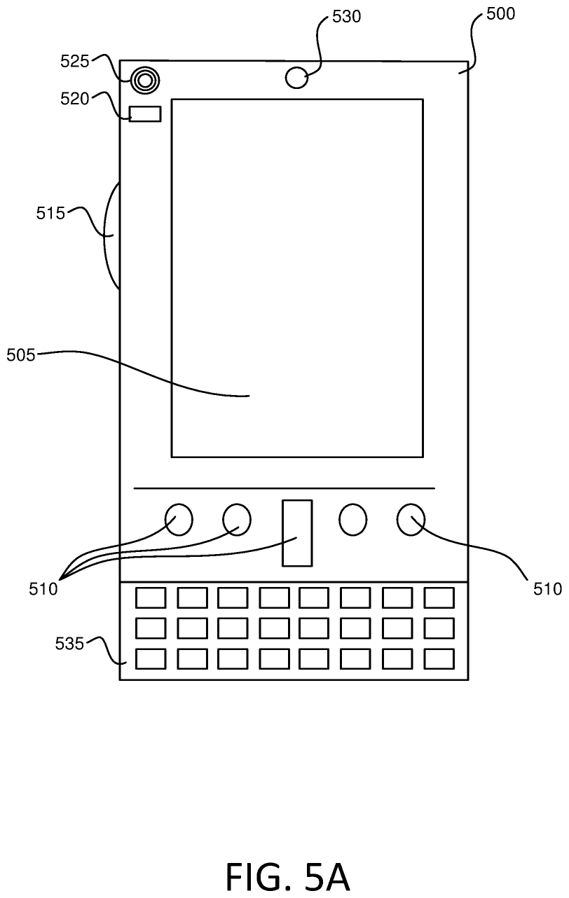

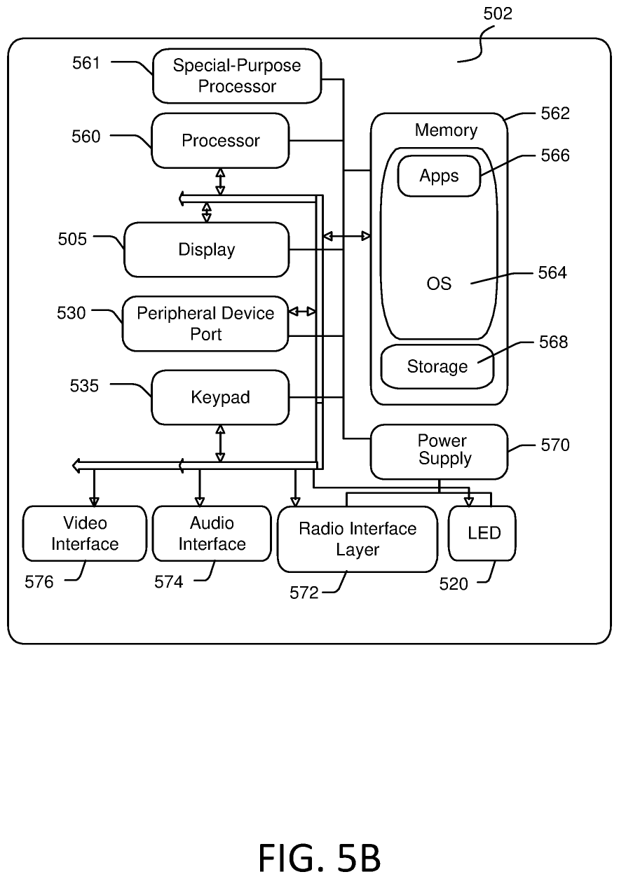

FIGS. 5A and 5B illustrate a computing device or mobile computing device 500, for example, a mobile telephone, a smart phone, wearable computer (such as a smart watch), a tablet computer, a laptop computer, and the like, with which aspects of the disclosure may be practiced. In some aspects, the client utilized by a user (e.g., a user of client device 102 in FIG. 1) may be a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included as an optional input element, a side input element 515 allows further user input. The side input element 515 may be a rotary switch, a button, or any other type of manual input element. In alternative aspects, mobile computing device 500 may incorporate more or less input elements. For example, the display 505 may not be a touch screen in some aspects. In yet another alternative aspect, the mobile computing device 500 is a portable phone system, such as a cellular phone. The mobile computing device 500 may also include an optional keypad 535. Optional keypad 535 may be a physical keypad or a “soft” keypad generated on the touch screen display. In various aspects, the output elements include the display 505 for showing a graphical user interface (GUI), a visual indicator 520 (e.g., a light emitting diode), and/or an audio transducer 525 (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of computing device, a server (e.g., an application server 110 and an auto data tagger 140 in FIG. 1), a mobile computing device, etc. That is, the mobile computing device 500 can incorporate a system 502 (e.g., a system architecture) to implement some aspects. The system 502 can implemented as a “smart phone” capable of running one or more applications (e.g., browser, e-mail, calendaring, contact managers, messaging clients, games, and media clients/players). In some aspects, the system 502 is integrated as a computing device, such as an integrated digital assistant (PDA) and wireless phone.

One or more application programs 566 may be loaded into the memory 562 and run on or in association with the operating system 564. Examples of the application programs include phone dialer programs, e-mail programs, information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500 described herein.

The system 502 has a power supply 570, which may be implemented as one or more batteries. The power supply 570 might further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the operating system 564, and vice versa.

The visual indicator 520 (e.g., LED) may be used to provide visual notifications, and/or an audio interface 574 may be used for producing audible notifications via the audio transducer 525. In the illustrated configuration, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with aspects of the present disclosure, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data/information may be readily transferred between computing devices for storage and use according to well-known data/information transfer and storage means, including electronic mail and collaborative data/information sharing systems.

As will be understood from the foregoing disclosure, one aspect of the technology relates to a system comprising: at least one processor; and memory storing instructions that, when executed by the at least one processor, causes the system to perform a set of operations. The set of operations comprises: generating a set of candidate patterns based at least in part on: data of a first column of a data store; and data of a second column of the data store; generating, using the set of candidate patterns, a first set of pattern scores associated with the first column of the data store; ranking the set of candidate patterns based on the first set of pattern scores; and validating new data associated with the first column using a pattern of the ranked set of candidate patterns. In an example, the set of operations further comprises: providing, to a computing device, an indication of the ranked set of candidate patterns; and receiving, from the computing device, a selection of the pattern of the ranked set of candidate patterns. In another example, the set of operations further comprises: automatically selecting the pattern of the ranked set of candidate patterns based on determining the pattern is a highest-ranked pattern of the ranked set of candidate patterns. In a further example, validating the new data using the pattern comprises: determining at least a part of the new data does not conform to the pattern; and based on determining that at least a part of the new data does not conform to the pattern, generating a validation failure indication associated with the part of the new data. In yet another example, the first set of pattern scores comprises at least one of: an impurity score for the pattern that indicates a percentage of rows of the first column that do not conform to the pattern; or a coverage score for the pattern associated with a number of columns of the data store that conform to the pattern. In a further still example, the first set of pattern scores comprises a first tolerance parameter for the pattern; and validating the new data further comprises: generating a second tolerance parameter for the new data based on the pattern; and evaluating the first tolerance parameter and the second tolerance parameter to determine whether a difference is statistically significant. In another example, the second column comprises a plurality of subdomains; the generated set of candidate patterns comprises at least: a first subset of patterns associated with a first subdomain of the plurality of subdomains; and a second subset of patterns associated with a second subdomain of the plurality of subdomains.

Another aspect of the technology relates to another system comprising at least one processor; and memory storing instructions that, when executed by the at least one processor, causes the system to perform a set of operations. The set of operations comprises: receiving a request for a set of candidate patterns for a column of a data store; determining, based on the column, a set of pattern scores associated with a combined pattern set of the data store; ranking a plurality of patterns in the combined pattern set based on the set of pattern scores; and providing, in response to the request, at least a part of the ranked plurality of patterns. In an example, the set of operations further comprises: receiving an indication of a selection of a pattern of the ranked plurality of patterns; and generating an association between the column and the indicated pattern. In another example, the indication of the selection of the pattern further comprises an edited pattern. In a further example, the set of operations further comprises: validating new data associated with the column using the indicated pattern based on the association. In yet another example, the set of operations further comprises: determining at least a part of the new data does not conform to the indicated pattern; and based on determining that at least a part of the new data does not conform to the indicated pattern, generating a validation failure indication associated with the part of the new data. In a further still example, the set of pattern scores comprises at least one of: an impurity score for the pattern that indicates a percentage of rows of the column that do not conform to the pattern; or a coverage score for the pattern associated with a number of columns of the data store that conform to the pattern.

In still further aspects, the technology relates to a method of data validation using inferred pattern generation. The method comprises: generating a set of candidate patterns based at least in part on: data of a first column of a data store; and data of a second column of the data store; generating, using the set of candidate patterns, a first set of pattern scores associated with the first column of the data store; ranking the set of candidate patterns based on the first set of pattern scores; and validating new data associated with the first column using a pattern of the ranked set of candidate patterns. In an example, the method further comprises: providing, to a computing device, an indication of the ranked set of candidate patterns; and receiving, from the computing device, a selection of the pattern of the ranked set of candidate patterns. In another example, the method further comprises automatically selecting the pattern of the ranked set of candidate patterns based on determining the pattern is a highest-ranked pattern of the ranked set of candidate patterns. In a further example, validating the new data using the pattern comprises: determining at least a part of the new data does not conform to the pattern; and based on determining that at least a part of the new data does not conform to the pattern, generating a validation failure indication associated with the part of the new data. In yet another example, the first set of pattern scores comprises at least one of: an impurity score for the pattern that indicates a percentage of rows of the first column that do not conform to the pattern; or a coverage score for the pattern associated with a number of columns of the data store that conform to the pattern. In a further still example, the first set of pattern scores comprises a first tolerance parameter for the pattern; and validating the new data further comprises: generating a second tolerance parameter for the new data based on the pattern; and evaluating the first tolerance parameter and the second tolerance parameter to determine whether a difference is statistically significant. In another example, the second column comprises a plurality of subdomains; the generated set of candidate patterns comprises at least: a first subset of patterns associated with a first subdomain of the plurality of subdomains; and a second subset of patterns associated with a second subdomain of the plurality of subdomains.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
generating a set of candidate patterns based at least in part on:
data of a first column of a data store; and
data of a second column of the data store;
generating, using the set of candidate patterns, a first set of pattern scores associated with the first column of the data store;
ranking the set of candidate patterns based on the first set of pattern scores; and
validating new data associated with the first column using a pattern of the ranked set of candidate patterns.

2. The system of claim 1, wherein the set of operations further comprises:
providing, to a computing device, an indication of the ranked set of candidate patterns; and
receiving, from the computing device, a selection of the pattern of the ranked set of candidate patterns.

3. The system of claim 1, wherein the set of operations further comprises:
automatically selecting the pattern of the ranked set of candidate patterns based on determining the pattern is a highest-ranked pattern of the ranked set of candidate patterns.

4. The system of claim 1, wherein validating the new data using the pattern comprises:
determining at least a part of the new data does not conform to the pattern; and
based on determining that at least a part of the new data does not conform to the pattern, generating a validation failure indication associated with the part of the new data.

5. The system of claim 1, wherein the first set of pattern scores comprises at least one of:
an impurity score for the pattern that indicates a percentage of rows of the first column that do not conform to the pattern; or
a coverage score for the pattern associated with a number of columns of the data store that conform to the pattern.

6. The system of claim 1, wherein:
the first set of pattern scores comprises a first tolerance parameter for the pattern; and
validating the new data further comprises:
generating a second tolerance parameter for the new data based on the pattern; and
evaluating the first tolerance parameter and the second tolerance parameter to determine whether a difference is statistically significant.

7. The system of claim 1, wherein:
the second column comprises a plurality of subdomains;
the generated set of candidate patterns comprises at least:
a first subset of patterns associated with a first subdomain of the plurality of subdomains; and
a second subset of patterns associated with a second subdomain of the plurality of subdomains.

8. A system comprising:
at least one processor; and
memory storing instructions that, when executed by the at least one processor, causes the system to perform a set of operations, the set of operations comprising:
receiving a request for a set of candidate patterns for a column of a data store;
determining, based on the column, a set of pattern scores associated with a combined pattern set of the data store;
ranking a plurality of patterns in the combined pattern set based on the set of pattern scores; and
providing, in response to the request, at least a part of the ranked plurality of patterns.

9. The system of claim 8, wherein the set of operations further comprises:
receiving an indication of a selection of a pattern of the ranked plurality of patterns; and
generating an association between the column and the indicated pattern.

10. The system of claim 9, wherein the indication of the selection of the pattern further comprises an edited pattern.

11. The system of claim 9, wherein the set of operations further comprises:
validating new data associated with the column using the indicated pattern based on the association.

12. The system of claim 11, wherein the set of operations further comprises:
determining at least a part of the new data does not conform to the indicated pattern; and
based on determining that at least a part of the new data does not conform to the indicated pattern, generating a validation failure indication associated with the part of the new data.

13. The system of claim 8, wherein the set of pattern scores comprises at least one of:
an impurity score for the pattern that indicates a percentage of rows of the column that do not conform to the pattern; or
a coverage score for the pattern associated with a number of columns of the data store that conform to the pattern.

14. A method of data validation using inferred pattern generation, the method comprising:
generating a set of candidate patterns based at least in part on:
data of a first column of a data store; and
data of a second column of the data store;
generating, using the set of candidate patterns, a first set of pattern scores associated with the first column of the data store;
ranking the set of candidate patterns based on the first set of pattern scores; and
validating new data associated with the first column using a pattern of the ranked set of candidate patterns.

15. The method of claim 14, further comprising:
providing, to a computing device, an indication of the ranked set of candidate patterns; and
receiving, from the computing device, a selection of the pattern of the ranked set of candidate patterns.

16. The method of claim 14, further comprising:
automatically selecting the pattern of the ranked set of candidate patterns based on determining the pattern is a highest-ranked pattern of the ranked set of candidate patterns.

17. The method of claim 14, wherein validating the new data using the pattern comprises:
determining at least a part of the new data does not conform to the pattern; and
based on determining that at least a part of the new data does not conform to the pattern, generating a validation failure indication associated with the part of the new data.

18. The method of claim 14, wherein the first set of pattern scores comprises at least one of:
an impurity score for the pattern that indicates a percentage of rows of the first column that do not conform to the pattern; or
a coverage score for the pattern associated with a number of columns of the data store that conform to the pattern.

19. The method of claim 14, wherein:
the first set of pattern scores comprises a first tolerance parameter for the pattern; and
validating the new data further comprises:
generating a second tolerance parameter for the new data based on the pattern; and
evaluating the first tolerance parameter and the second tolerance parameter to determine whether a difference is statistically significant.

20. The method of claim 14, wherein:
the second column comprises a plurality of subdomains;
the generated set of candidate patterns comprises at least:
a first subset of patterns associated with a first subdomain of the plurality of subdomains; and
a second subset of patterns associated with a second subdomain of the plurality of subdomains.
